(19) United States
(12) Patent Application Publication
(10) Pub. No.: US 2023/0074633 A1
(43) Pub. Date: Mar. 9, 2023

(54) AIRCRAFT MANAGEMENT SYSTEM AND METHOD OF USE

(71) Applicant: Ivry SHAPIRA, Oranit (IL)

(72) Inventor: Ivry SHAPIRA, Oranit (IL)

(21) Appl. No.: 17/794,846

(22) PCT Filed: Jan. 22, 2021
(86) PCT No.: PCT/IL2021/050072

§ 371 Date: Jul. 22, 2022

(30) Foreign Application Priority Data
Jan. 23, 2020 (IL) 272212

(51) Int. Cl. G08G 5/00

(52) U.S. Cl. CPC G08G 5/0026; G08G 5/003; G08G 5/0043; G08G 5/0082

(57) ABSTRACT

An aircraft management system and method of use are presented. The system comprises an application sewer, an application programming interface, a database and a graphical user interface. The interface comprises a dashboard and a plurality of stages for managing and monitoring aircraft traffic in any defined and controlled space cell. Every aircraft is assigned a flight strip with the particular details of its flight, where ground control arranges the presentation of the aircrafts that enter the space cell under its supervision. Accordingly, the flight strips of aircrafts from different departures to different destinations and belonging to different formations or airlines can be grouped for better monitoring and control in any particular space cell. This also improves communication of the aerial traffic to neighbor controls that can ungroup and rearrange entering traffic according to the state of aircrafts in their cells.

### TECHNICAL FIELD

This disclosure relates to an aircraft management system and method of use. More specifically and without limitation, this disclosure relates to an aircraft formations management system, and related methods of use.

### COPYRIGHT NOTICE

At least a portion of the disclosure of this patent document contains material that is subject to copyright protection. The copyright owner has no objection to the facsimile reproduction by anyone of the patent document or the patent disclosure, as it appears in the Patent and Trademark Office patent files and/or records, but otherwise reserves all copyright rights whatsoever. The following notice applies to the software and data as described below and in the drawings that form a part of this document: Copyright Ivry Shapira. All rights reserved.

### BACKGROUND

Airline and/or airport management systems are well known in the art. Airlines and airports have been managed with a few different systems and methods over the duration of aircraft history. Known airline and airport management systems related to aircraft and other vehicles used in and around airports are a large part of airport and/or aircraft administration. These systems and methods are also used to manage and/or track the safe and orderly movement of aircraft, including but not limited to, commercial airliner movements, drone movements, and the like.

Airport administration and management is not limited to aircraft movement. Aircraft management also includes the activities of setting the strategy of airports to gather and provide information on airline commercial and operational priorities. Additionally, aircraft management may also be directed to military operations and formations including aircraft and the like. Furthermore, aircraft management covers a broad overview of airline management.

A primary aspect of any airline management system is a flight management system. Flight management is a fundamental component of modern commercial airline avionics. Additionally, flight management is critical in military function and operation in both manned and unmanned aircraft. Furthermore, flight management systems are becoming more and more common with complex drone operations in non-military functions Flight management systems are well known in the art and automate a wide variety of in-flight tasks, reducing the workload on flight crew and others involved. Additionally, flight management systems are also used to create a flight plan. Flight plans are generally determined on the ground, before any aircraft depart. Flight plans are either decided by the pilot or a professional dispatcher. Some flight plan uses include, but are not limited to, tactical requirements, search patterns, rendezvous, in-flight refueling orbits, calculated air release points, and other special flight plans.

In general, flight plans and flight management systems are used to determine guidance and position of aircraft at departure and during the air. Commonly, in order to manage air traffic created by numerous flight patterns and or a plurality of air vehicles, air traffic control units (or “ATC units”) are used to provide supervision and instructions to aircraft.

Air traffic controllers are personnel are responsible for the safe, orderly, and expeditious flow of air traffic in the global air traffic control system. Usually stationed in air traffic control centers and control towers on the ground, air traffic controllers monitor the positions, speed, and altitude of aircraft in their assigned airspace. Air traffic controllers monitor these credentials visually, by radar, and by providing instructions to pilot via radio using a particular frequency for communication in a particular circumstance.

In some air traffic control units, there are more than a single controller. This is especially common in commercial airlines and/or military operations. Additionally, often times the planes and/or other aircraft are controlled by a different controller depending on their location in the sky or flight stage. Some various stages in flight, include, but are not limited to: landing, takeoff, instrument processes, practice, navigation, free flight in an area away from the airport, and the like.

The methods of managing aircraft in space and the used control systems, commonly used in the art today, are varied. In the control units, there are radios to communicate with the aircraft and give the aircraft flight instructions. In this way, a user or a program can communicate with a pilot or autonomous pilot to provide flight instructions. In manual methods, used today, certain towers use hand written notes, which are transferred from controller to controller, including all flight details of each aircraft.

Other methods commonly used today to facilitate the management of aircraft include software programs. Some software programs are available today that help manage aircraft and transfer information between flight controllers and aircraft.

In software applications in use today, the method used by these systems is referred to as Electronic Flight Strips. Electronic flight strips combine the data for each aircraft into one data block (an “electronic strip”). The electronic strip can be moved from section to section on the controllers dashboard, such that the electronic strip can be digitally managed by a controller. As the strip is digitally managed by the controller, who moves the strip from dashboard to dashboard, the location of the strip can be seen by others. In this way, others can see the strip, in the applied location, as a set of information. Furthermore, the aircraft pilot or automated pilot can accept new information changed on the flight strip as a set of instructions for operations. In this way, instructions are transferred from controller to aircraft.

These systems are designed for the management of airplanes flying separately in the airspace. As one example, three commercial airliners may all be departing Chicago. One airplane may be heading for New York, another departing for Paris, and yet another departing for Tel Aviv. Each of these three aircraft are flying separately in the airspace. Each of these aircraft are flying with their own flight pattern in their own direction and possibly even departing from a different runway. Contrast this scenario with a platoon of aircraft operating cooperatively in a military formation, or contrast the scenario with a set of hundreds of drones operating together. In these other scenarios, existing systems in the art are not suitable for the management of aircraft formations, squadrons, groups and/or other numbers of air platforms flying together or operating together in airspace.

Other additional problems which exist with today's flight and airline management systems is that the airplane must change radio frequency in accordance to its location or flight phase, such as taxiing, departure, arrival, approach, etc. Furthermore, some air traffic controllers use notes (which are often handwritten), wooden blocks with numbers, and the like to gather information about aircraft. These notes, often called strips can be transferred between controllers, if transferred by hand. These controllers can use the single note to gather all the information they need about a particular aircraft, however, the system is very inefficient.

Even in advanced electronically operated state of the art air traffic control towers, strips are used. The strips still operate as the main dashboard and/or display of information for controllers and serve as the main means of controller operations requests. Complicating matters further is that all of the existing systems are only capable of controlling each aircraft separately and are not built to manage a group of aircraft, or a formation of aircraft.

Thus, there is a need in the art for a software platform that can safely, easily, and effectively manage aircraft formations, squadrons, groups and/or other numbers of air platforms flying or operating together in airspace. Additionally, there is a need in the art for a system and method that provides familiarity of the current art in a way that the new system can be incorporated safely and used by those with familiarity of existing system. Thus, there is a need in the art for a system and method which improves upon the state of the art while providing a new system that can manage a plurality of aircraft with simplicity, familiarity, efficiency, and effectiveness.

### SUMMARY

An aircraft management system and method of use is presented herein. The aircraft management system and method of use presented herein adds to and improves upon the state of the art by providing a solution to existing aircraft formation management systems. Additionally, the aircraft management system and method of use presented herein allows flight controller personnel quick, efficient and safe control in managing a large number of aircraft. Additionally, the aircraft management system and method of use presented herein allows flight controller personnel the ability to manage a plurality, or large number of aircraft in space, airspace or beyond.

The aircraft management system and method of use presented herein allows aircraft controllers, pilots, autonomous systems and others involved to easily manage multiple aerial platforms including, but not limited to, civilian platforms, military platforms, fighter jets, helicopters, unmanned aerial vehicles, drones, gliders, firefighters, spacecraft and any other aerial and/or space platform.

Furthermore, the aircraft management system and method of use provides clarity in the current state of aircraft in an airspace. This includes, but is not limited to, functionality of various groups, including status, positioning, speeds, direction, and the like. In this way, managing aircraft groups and systems becomes more effective for both pilots and managers because of system groupings and clarity in understanding.

The aircraft management system and method of use presented herein, as used in association with air traffic controllers, collects data about each aircraft that is located in the allotted airspace and/or data about each aircraft that will be in the allotted airspace. Additionally, the aircraft management system and method of use interprets the data received in an easy to understand formation which interpolates various information for computation and presentation purposes.

Subsequently, the data collected by the aircraft management system and method of use can be transmitted by the system before the aircraft call of the Air Traffic Controller. In other words, the system may have computed the incoming aircraft and decided how to handle incoming aircraft even before the pilot of the incoming aircraft alerted the air traffic controller of its approach. Additionally, the aircraft management system and method of use allows data entry to aircraft and data change, even during the live operation of aircraft and/or aircraft groupings.

In one example, once the data is entered into the aircraft management system and/or once data is collected by the aircraft management system (in association with other components such as radar and the like), the system automatically groups strips for planes that are flying in the formations into one strip that will appear in the system control panel of the system, which can be displayed in various ways such as table display, list, map, wireframe ect. The combined strip can be moved from section to section, within the system, in accordance with the aircraft or formation location or flight stage. In this way, the control panel provides a visual view, via a graphical user interface, of the information of each aircraft or group of aircraft to all of those with authorization to view. In this way, large groups are more easily and efficiently managed by the system.

In one example, the aircraft management system and method are able to change the strip location on the control panel manually by dragging the strip from one place to another or any other manual operation. In the arrangement shown, as one example, the strip can also be moved in the control panel automatically according to a set of rules and function pre-programmed into the system which coordinate with location of the aerial/space platform and/or according to the platform's reporting. This set of input will lead to an output which causes the change in the strip location from one section to another, or from multiple sections to other multiple sections.

In this example, a combined strip (meaning at least two strips or at least two aircraft), can be seen as one strip on the control panel. In this way, the system is more efficient and easier to understand than existing systems. In this way, the system offers an extended view which provides more information directly, and more accessible, to a controller. In this way, each platform, or each aircraft, within each group can provide a plurality of information at the same time to a controller.

In one example, the system allows for grouping aircraft manually. In another example, the system uses artificial intelligence and/or a set of rules to evaluate inputs and determine groupings of aircraft. This data analysis capability allows the system to compute and/or determine which aircraft are flying together. In this way, the system can determine which aircraft should be grouped on the same strip. In this way, the system can connect previously ungrouped aircraft into a single strip without any manual inputs. Additionally, the system is capable of ungrouping aircraft autonomously based on input, in a similar way.

In this way, the system uses all the information and/or inputs available about a particular aircraft (including air speed, altitude, and other information) available to the aircraft management system to analyze and decide which aircraft to group or ungroup. Some examples of the various data used in these computations by the system include, but are not limited to, call signs, radar input, global positioning data, planned route information, real-time route information, and the like. In addition, the system does the analysis of this information, including grouping and ungrouping, in real time.

Said another way, the aircraft management system and a method of using provides for a system which analyzes the real-time flight data of each aircraft and combines this data together in the same flight area so as to provide an interpolation of this data so that a plurality of aircraft can be grouped and/or degrouped.

The system provides for these functions autonomously. However, these functionalities can be manually completed as well. In addition to manual operations, which may be less safe than automated systems, the system allows for tracking and recording of every decision made by the system, especially noting manual decisions made. As more manual operation is done, the system learns the controller's needs and changes the grouping algorithm accordingly to improve and adapt to each user, whether the user is an air traffic controller or a pilot or other user.

In another example, and in creating variety in grouping, the system can connect each aircraft or group of aircraft to a single strip can be done either by displaying a single strip, which combines all the aircraft that are linked to it, or by linking several stripes that are linked to each other. In this way, a variety and more complex grouping can be created such that groups can be linked to other groups, either temporarily or permanently. Many groups may move together for a period of time but then break into other groups. The control panel can manage these complex groupings, depending on a user's needs.

Additionally, and in other functionality, the system can also send flight information to the group, all simultaneously. In this way, flight information can be displayed to a plurality of aircraft that are connected to a single system or group. In this way, data can be sent to the entire group, including, but not limited to flight data, alerts, new flight instructions, and the like in a fast and efficient way. In this way, multiple aircraft can be managed more efficiently and easily. Once the group receives the data, the plurality of aircraft return a confirmation receipt. These and other functions are included in the system herein.

Thus, it is a primary object of the disclosure to provide an aircraft management system and method of use that can group aircraft and provide a more efficient and safe system of aircraft management.

Another object of the disclosure is to provide an aircraft management system and method of use that is easy to use.

Yet another object of the disclosure is to provide an aircraft management system and method of use that is reliable.

Another object of the disclosure is to provide an aircraft management system and method of use that is safe.

Yet another object of the disclosure is to provide an aircraft management system and method of use that can group multiple aircraft to a single control strip.

Another object of the disclosure is to provide an aircraft management system and method of use that can group multiple groups of aircraft to a single control strip.

Yet another object of the disclosure is to provide an aircraft management system and method of use that combines aerial platforms into groups.

Another object of the disclosure is to provide an aircraft management system and method of use that displays grouped aircraft in an easy to understand way.

Yet another object of the disclosure is to provide an aircraft management system and method of use that displays grouped aircraft on a dashboard (which can be displayed in various ways such as table display, list, map, wireframe ect.)

Another object of the disclosure is to provide an aircraft management system and method of use that provides a means to move grouped aircraft as a single strip throughout various sections of a dashboard.

Yet another object of the disclosure is to provide an aircraft management system and method of use that provides moving grouped aircraft according to stages.

Another object of the disclosure is to provide an aircraft management system and method of use that autonomously moves aircraft to sections depending on an input.

Yet another object of the disclosure is to provide an aircraft management system and method of use that provides for manually moving and grouping a plurality of aircraft.

Another object of the disclosure is to provide an aircraft management system and method of use that allows aircraft status to be changed as a single aircraft or as a group of aircraft.

Yet another object of the disclosure is to provide an aircraft management system and method of use that can display individual aircraft information even when the aircraft is in a grouping.

Another object of the disclosure is to provide an aircraft management system and method of use that provides a control system capable of displaying a group of aircraft as a single strip.

Yet another object of the disclosure is to provide an aircraft management system and method of use that allows a single strip to be expanded and/or extended in a way that shows information on all aircraft of the grouping.

Another object of the disclosure is to provide an aircraft management system and method of use that provides a means for sending flight instructions.

Yet another object of the disclosure is to provide an aircraft management system and method of use that provides for sending flight instructions to an entire group of aircraft simultaneously.

Another object of the disclosure is to provide an aircraft management system and method of use that automatically sends flight instructions to a group of aircraft when data is changed on a strip.

Yet another object of the disclosure is to provide an aircraft management system and method of use that displays flight information in real-time to both air traffic controller and pilot.

Another object of the disclosure is to provide an aircraft management system and method of use that displays flight information in real-time to any user with access.

Yet another object of the disclosure is to provide an aircraft management system and method of use that communicates flight information and changes electronically.

Another object of the disclosure is to provide an aircraft management system and method of use that links all platforms to the same control system.

Yet another object of the disclosure is to provide an aircraft management system and method of use that provides viewing of the status of the aerial platforms according to the data sent to the control system from the platform.

Another object of the disclosure is to provide an aircraft management system and method of use that provides linking groups together in a manner that controlling one group affects other linked groups.

Yet another object of the disclosure is to provide an aircraft management system and method of use that provides for linking groups in a manner that sending a first set of instructions to a first group automatically sends a second set of instructions to a second group.

Another object of the disclosure is to provide an aircraft management system and method of use that provides for automated aircraft group control.

Yet another object of the disclosure is to provide an aircraft management system and method of use that provides for combining a first group and a second group into a single group.

Another object of the disclosure is to provide an aircraft management system and method of use that provides for linking groups in a manner that sending a first set of instructions to a first group automatically sends a second set of instructions to a second group and a third set of instructions to a third group.

These and other objects, features, or advantages of the present disclosure will become apparent from the specification and claims.

### BRIEF DESCRIPTION OF THE DRAWINGS

The drawings accompanying and forming part of this specification are included to depict certain non-limiting aspects and embodiments of the disclosure without limiting the broadest scope of the invention

FIGS. 1-4 illustrate common modes of formation of airspace groupings.

FIG. 5 illustrates the aircraft management system.

FIG. 6 illustrates functional display for grouping strips for efficiently managing a plurality of aircrafts.

FIG. 7 illustrates functional display with a drag feature for dragging a strip from one section to another section.

FIG. 8 illustrates functional display comprising various individual tabs arranged to easily help a user to navigate through various stages of air travel.

FIG. 9 illustrates functional display with callsigns showing bits of information of airlines.

FIG. 10 illustrates functional display of strips with a link feature.

FIG. 11 illustrates functional display with an approach tab and taxiing that enable updating the status of an aircraft or group of aircraft by dragging strips from one section to another.

FIG. 12 illustrates additional functionalities for are shown in the functional display in

FIG. 13 illustrates

FIG. 14 illustrates

FIG. 15 illustrates an arrangement of aircrafts with associated parameters, which are used to analyze them into groups.

FIG. 16 illustrates an aircraft management system with remote servers, databases, and/or computers.

### DETAILED DESCRIPTION OF THE DRAWINGS

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides and the like are referenced according to the views, pieces and figures presented. It should be understood, however, that the terms are used only for purposes of description, and are not intended to be used as limitations. Accordingly, orientation of an object or a combination of objects may change without departing from the scope of the disclosure.

Reference throughout this specification to “one embodiment,” “an embodiment,” “one example,” or “an example” means that a particular feature, structure, or characteristic described in connection with the embodiment or example is included in at least one embodiment of the present disclosure. Thus, the appearance of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“Saas”), Platform as a Service (“PaaS”), and Infrastructure as a Service (“IaaS”)), and deployment models (e.g., private cloud, community cloud, public cloud, and hybrid cloud).

The flowchart and block diagrams in the attached figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

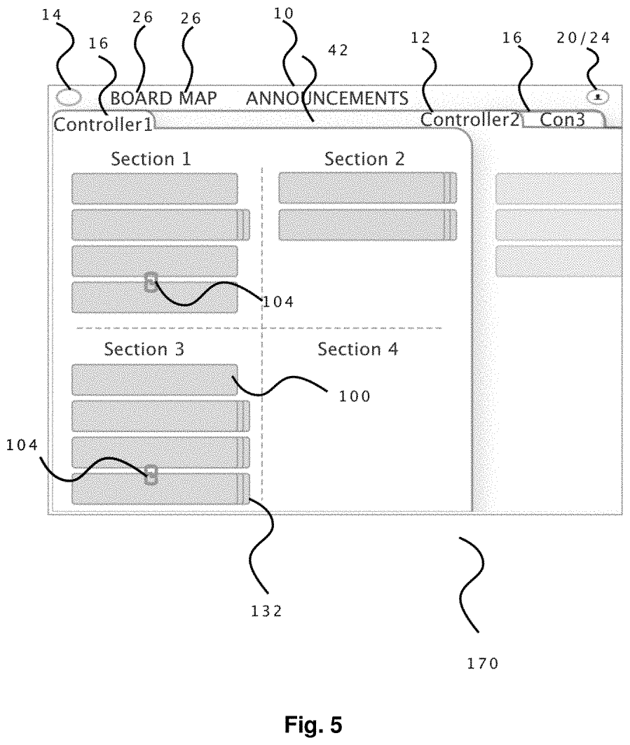

The aircraft management system 10, which is schematically depicted in FIG. 5, may be formed of any suitable size, shape, and design and is configured to provide a means for grouping a plurality of aircrafts into a single strip such that a plurality of aircrafts can be managed more efficiently, safely, and effectively. System 10 may be configured to integrate with existing management platforms to allow users to acclimate to designs and codes and the like. System 10 may be adopted for various jurisdictions and rules customized in a way that delivers appropriate safety regulations, especially when it comes to autonomous functions of the system 10.

System:

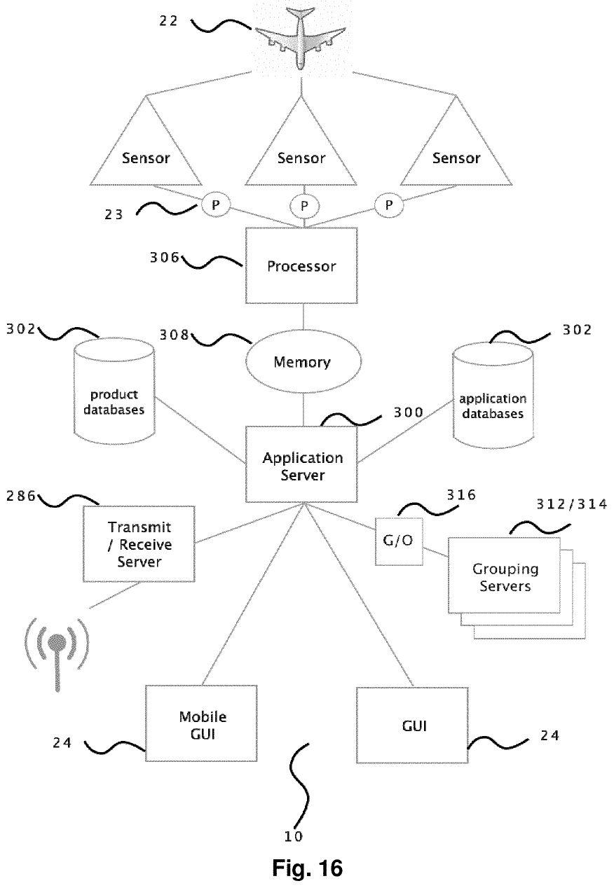

With reference to the figures, an aircraft management system 10 (see FIGS. 5 and 16) and method of use is presented (hereafter known as “aircraft system”, “management system”, or simply “system”). Aircraft system 10 is formed of any suitable size, shape and design. In the arrangement shown, as one example, management system 10, which may comprise remote servers, databases, application servers, application databases, product databases, mobile applications, displays, mobile displays, and/or computers that fulfill the functions disclosed herein, also includes, in the embodiments depicted, a graphical user interface 12, an account 14, a controller 16, a pilot 18, a viewer 20, an aircraft 22, a plurality of access points 24, a map (or “board”, or “dashboard”) 26, a formation 28 (see FIG. 5), a strip 100, a group strip 102, a link 104, and a control system 170, among other components, features, hardware, software, and instructions.

In the arrangement shown, as one example, system 10 may include a controller 16, a pilot 18, a viewer 20, and the like (also known as a “user”, “controllers”, “pilots”, “managers”, and the like). These terms are used to describe the various humans that interact with system 10 or that are affected by the interactions and guidance of system 10. In other words, these descriptions may be any person and/or entity who may utilize and/or interact with system 10.

Additionally, and in the arrangement shown, as one example, system 10 comprises remote servers, databases, and/or computers that fulfill the functions disclosed and described herein. In the embodiment depicted in FIG. 16, system 10 comprises an application server 300. Application server 300 comprises one or more computer systems adapted to transmit and receive data regarding selected datasets related to various users and/or datasets related to multiple users. Application server 300 is adapted to query database with unique identification codes to retrieve a list of brand rules related to various users. Application server 300 may transmit product data related to designs, codes, products and rules with respect to a single user and/or multiple users. Application server 300 is also adapted to query a database 302 to add or collect data 304, so this data 304 may be processed by a processor 306. The data may be stored on a memory 308. This query includes receiving and sending product identification codes and product data. Additionally, the application server 300 may communicate with a mobile application 310 and/or a plurality of computers 312, which is adapted to present the product information in a form conducive to being viewed on a mobile device and/or handheld device. Additionally, computers and/or servers 312 may be adapted with a set of rules to perform data analysis 314 and data analysis grouping 316. GUI 25 and Mobile GUI 27 are user interfaces for desktop and mobile portable devices, respectively, that receive data and data analysis results from the application server 300 for display, monitoring and managing flight control of the aircrafts in an airspace.

In the arrangement shown, as one example, system 10 includes a graphical user interface 12. Graphical user interface 12 is formed of any suitable size, shape, and design and is configured to be the main interaction of system 10 with any user. Graphical user interface 12 is further discussed herein.

Account: In the arrangement shown, as one example, system 10 includes an account 14 (see FIG. 5). Account 14 is formed of any suitable size, shape, and design and is configured to provide a user with access to the system 10. In the arrangement shown, as one example, an account 14 is necessary for safety reasons and may be necessary to comply with various regulations. Account 14 provides a username and access password and/or code for a user granting the user access to all or partial functions of system 10. In this way, account 14 or a plurality of accounts assigned to pilots, controllers, and other users allows for customized user interfaces, allows for restricted access, and controls the safety and improves the efficiency of system 10.

In this arrangement, and as is shown, account 14 can be signed into using a username and password. Additionally, a user can log out of the account 14 at anytime, adjust account settings, and the like. A user can access account 14 and customize their profile at anytime through the graphical user interface 12. In the arrangement shown, as one example, this access to the account is displayed in the upper right portion of the screen.

Aircraft: In the arrangement shown, as one example, system 10 may include, but does not require at least one aircraft 22. Aircraft 22 is formed of any suitable size, shape, and design and is generally an object that is designed to move by manual control of a pilot or controller or autonomously of human intervention. In one arrangement, aircraft 22 is a commercial airliner. Commercial airplanes are well known in the art and can be especially tricky to manage safely and efficiently in areas of cluster such as around airports. Indeed, airplanes, as one example of aircraft 22 will be generally discussed herein for simplicity.

Although a commercial airliner is one example of an aircraft 22, any other moving object may also be considered an aircraft 22. Other examples of aircraft 22 include smaller airplanes for transporting people and goods, military equipment such as fighter jets, drones, missiles, helicopters, unmanned aerial vehicles, gliders, firefighters, boats, submarines, and spacecraft. Furthermore, in the arrangement shown, generally vehicles which travel through airspace are considered, as this is the most common form of application with the greatest number of aircraft 22 to be controlled and/or managed, however, this system may be applied to watercraft which also travel through 3-dimensional spaces, as well as ground vehicles which travel in groups and may need organization. Additionally, aircraft 22 may be motor powered, jet powered, battery powered, powerless, or the like.

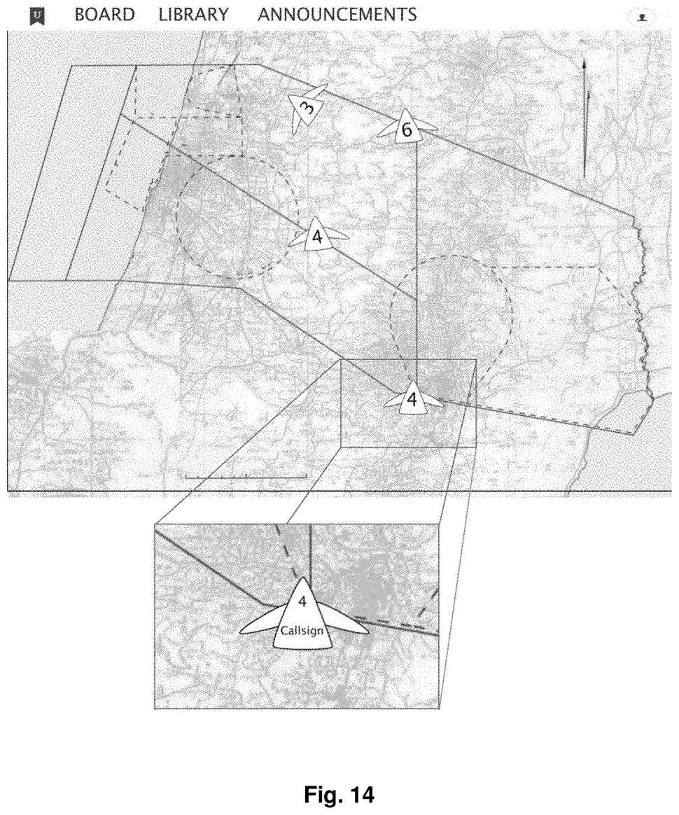

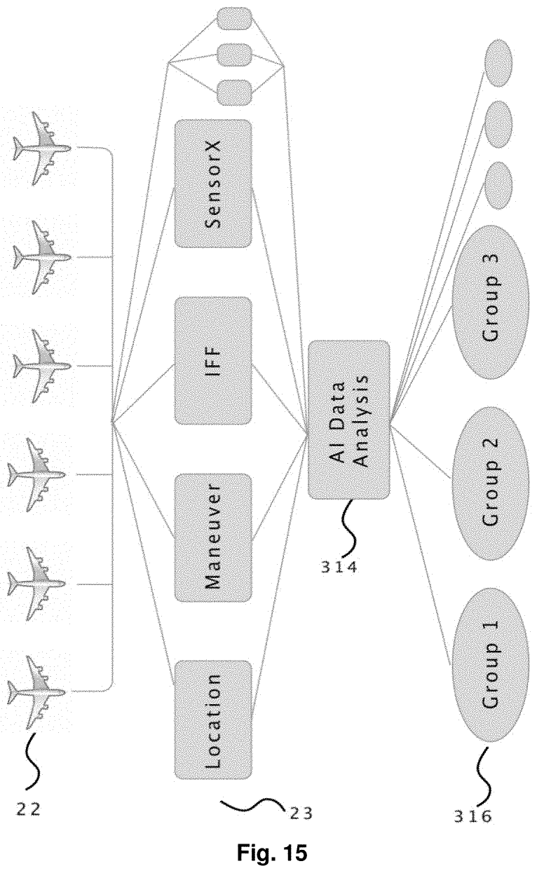

Aircraft Parameter: In the arrangement shown in FIG. 14, as one example, aircraft 22 includes at least one aircraft parameter 23. Aircraft parameter 23 (or simply “parameter”) is any defining characteristic of and/or associated with an aircraft 22. Examples of aircraft parameters 23 include, but are not limited to, aircraft identifiers, altitude, distance, takeoff point, landing point, traveling speed, air pressure, fuel levels, various capabilities such as: travel distance, passenger capacity, cargo capacity, equipment capabilities, night vision and/or night travel capabilities; country of origin, grouping information, callsigns, camera equipment, radar equipment, engine number, crew members, crew ranks, airspeed, ground speed, flight time, arrival time, departure time, coordinates, mission capability, and the like. These are some examples of parameters 23 that can be associated with an aircraft 22.

Access Point: In the arrangement shown in FIG. 5, as one example, system 10 includes an access point 24. Access point 24 is formed of any suitable size, shape, and design and is configured to provide a user with visual access to information related to system 10. Additionally, access point 24 may be designed to allow a user to provide input into system 10 and or make changes to information in system 10. In this way, access point may be a computer, mobile device and/or display screen and/or touch screen that displays a graphical user interface 12 and provides a user with a means to access information and other data in system 10 and or manipulate information and/or data within system 10. In changing information and/or manipulating data, the user may change that data for all who are accessing system 10, depending on the settings and their access levels.

Map/Board: In the arrangement shown, as one example, system 10 includes a map/board 26. Map/board 26 may be formed of any suitable size, shape, and design and is configured to provide visual indications to a user and display information related to aircraft 22 or a plurality of aircraft 22 in an easy to understand and quickly digestible manner. Maps or boards 26 have been used in the art for some time to locate aircraft on a map for visual indications of location.

In the arrangement shown, as one example, map/board 26 is capable of much more than indicating to a viewer the location of an aircraft 22. Map/board 26 may indicate to a user the callsign of an aircraft 22, the altitude of an aircraft 22 and/or other parameters 23 associated with an aircraft 22, all in addition to showing a live location of the aircraft as may be associated with global positioning satellites. In this way, map/board 26 may be used to display vital information needed to safely accommodate orders and maneuvering and/or grouping of aircraft.

Formation: In the arrangement shown, as one example, system 10 specializes in creating a formation and/or grouping aircraft so as to make operations of air traffic control more efficient, safe and effective. Additionally, formations may not be intentional grouping but used as a means for management so as to group aircraft 22 for informational display purposes only. Formations may be used to control multiple aircraft 22, such as sending out a single order which tells all aircraft 22 simultaneously what action to take. Additionally, formations may be used to portray information to a user about a group of aircraft that are not grouped for the same orders. For example, a formation may be a group of 10 aircraft 22 approaching a single airport. The air traffic controller may call any approaching aircraft a formation, or may call aircraft approaching from the west that are between 100 and 300 miles away, a single formation. This would be done for management purposes. Perhaps aircraft between 10,000 feet in altitude and 20,000 feet would be another formation. Additionally, aircraft with landing gear engaged could be another formation. Perhaps aircraft 22 taxiing for takeoff could be another formation.

In the arrangement shown, system 10 is capable of manual or automatic formation. Manual formation might be done by an air traffic controller, a dispatcher, a mission controller, or the like. Automatic formation can take place by a predetermined set of rules programmed into system 10. Additionally, these predetermined set of rules may include machine learning that learn from a controller. For example, if a particular controller regularly groups aircraft traveling between 12,000 feet in altitude and 18,000 feet in altitude, the system 10 will learn to automatically start grouping this set of aircraft and displaying the set of group aircraft to the user. Likewise this machine learning is ongoing. Furthermore, grouping and formations can be based on any aircraft parameter 23. Some examples of grouping and linking groups are displayed herein, discussed herein, and referenced in figures.

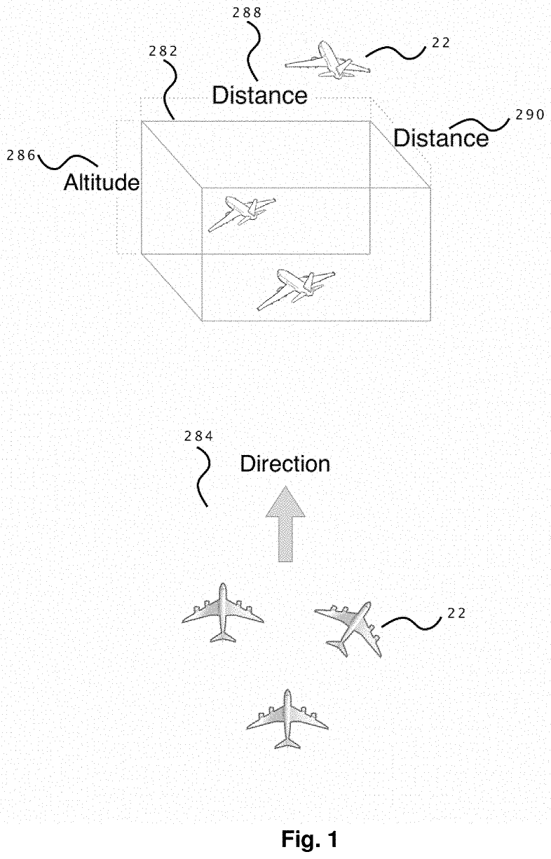

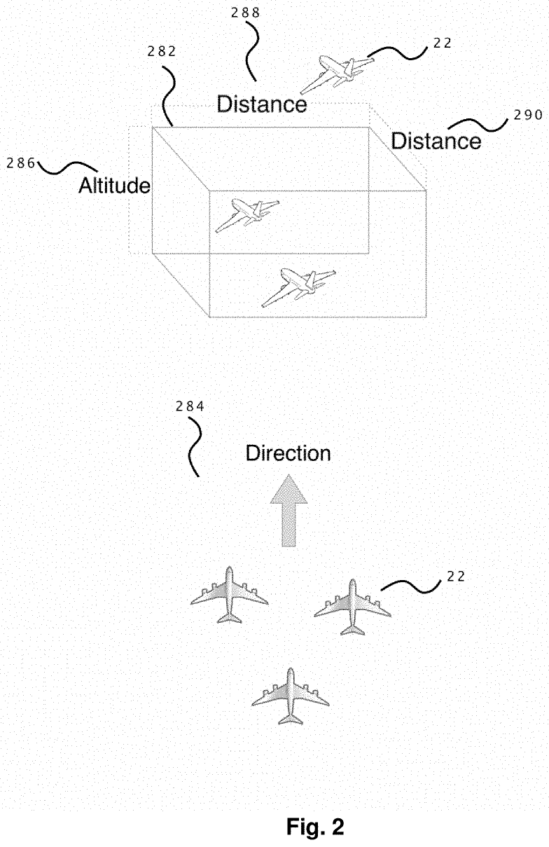

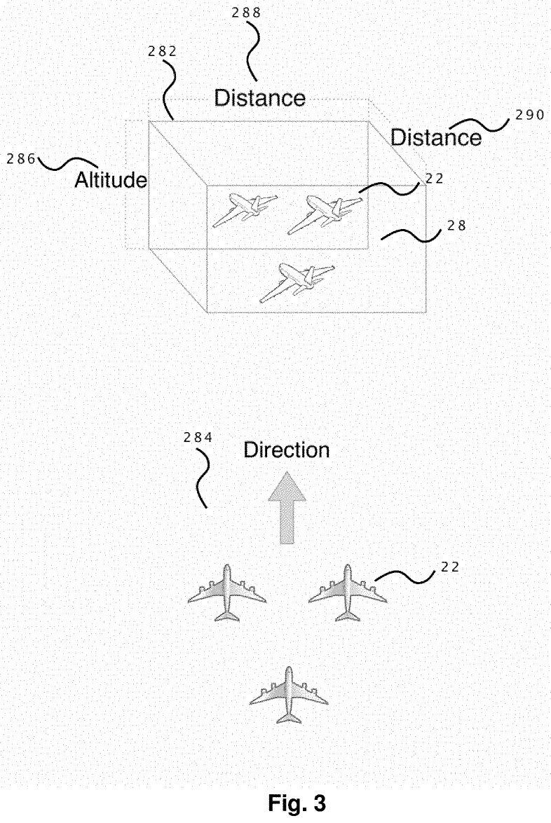

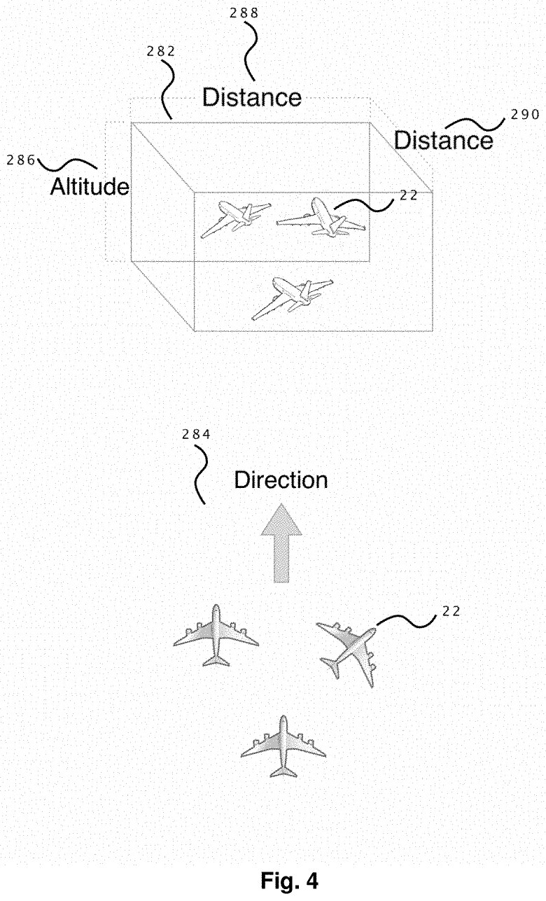

Common modes of formation include, but are not limited to, airspace grouping as illustrated in FIGS. 1-4. Airspace 282 or airspace grouping 282 includes grouping aircraft in the same airspace 282. Aircraft 22 traveling in different directions may be in same airspace 282. Aircraft at similar altitudes or traveling in similar directions may be in the same airspace 282. However, a first aircraft 22 traveling at a different altitude than a second aircraft may be in a different airspace depending on the predefined or manual airspace 282 desired. Airspace 282 can be defined as direction 284, altitude 286, distance x 288, distance y 290, and the like.

Strip: In the arrangement shown, as one example, system 10 includes a plurality of strips 100 (see FIG. 5). Strips 100 are formed of any suitable size, shape, and design and are configured to represent an aircraft 22. Commonly in the art, strips 100 have previously been formed of a single paper strip that represented a single airplane traveling or parked at a parked location. In this way, many airports and the like are still managed, via paper strips with writing on them to indicate to an air traffic controller various statuses and information. This method of managing airplanes, although expertly handled, can be ineffective.

Strips 100 as disclosed herein, are much more versatile and enhanced as opposed to anything in the art. Strips 100, in the arrangement shown, as one example, are capable of representing information, any information desired by a user, of a single aircraft 22 or a group of aircraft 22. In this way, and as shown and referenced in figures herein, a single strip can represent hundreds of aircraft 22 all at the same time, if so desired. In this way, a single strip could even represent many thousands of aircraft 22.

As one example, a single strip might represent 1,000 drones. In this way, a controller could send a single set of instructions. The instructions issued to a single strip could cause all of the drones to act in a coordinated way, each receiving the instructions simultaneously through system 10. In this way, aircraft 22, such as airplanes on an approach to an airport can be grouped, such that a controller can more effectively, efficiently, and safely manage airplane landings in a way that is cost effective and easy.

In the arrangement shown, as one example, strips 100 are displayed as generally rectangular shapes that have various information. In the arrangement shown, as one example, the strip 100 or plurality of strips 100 appear as a rectangle which is placed in a section. In this way, the strip 100 can be moved from section to section manually or automatically. In this way, a visual indication is provided to a user that shows something about the aircraft 22.

Additionally, this may indicate to a user what the next course of action is that a pilot should take. For example, if a controller drags the strip from a taxiing section to a takeoff section, this may indicate to the pilot of the aircraft that they are now ready for takeoff and that they can proceed with takeoff.

In the arrangement shown, as one example, strip 100 is designed to appear as a common, or known in the art, paper strip would appear to an air traffic controller. In this way, familiar look and feel are created so that aircraft controllers and the like know how to read and understand strips 100. Also, in this way, air traffic controllers and others know where to look on a strip 100 for information which is needed at any particular time. However, strips 100 may be customized to the desire of the user and/or the application in which the strips are used.

Traditionally, strips known in the art, and as shown herein, may include a verification symbol, a revision number, an identifier, a number of the aircraft, an airspeed, a sector, a computer identification number, a ground speed, a revised ground speed, a strip number, a previous fix number, an estimated time, a revised estimated time, an actual time, clearance information, arrows indicator, pilot estimated time, arrival/departure time, a fix, an altitude, a coordination fix, a pilots over next fix, a direction indicator, a requested altitude, a point of origin, pertinent remarks, beacon code, miscellaneous control data, control data transfer, and coordination indicators. These items define some of the items found on a typical strip.

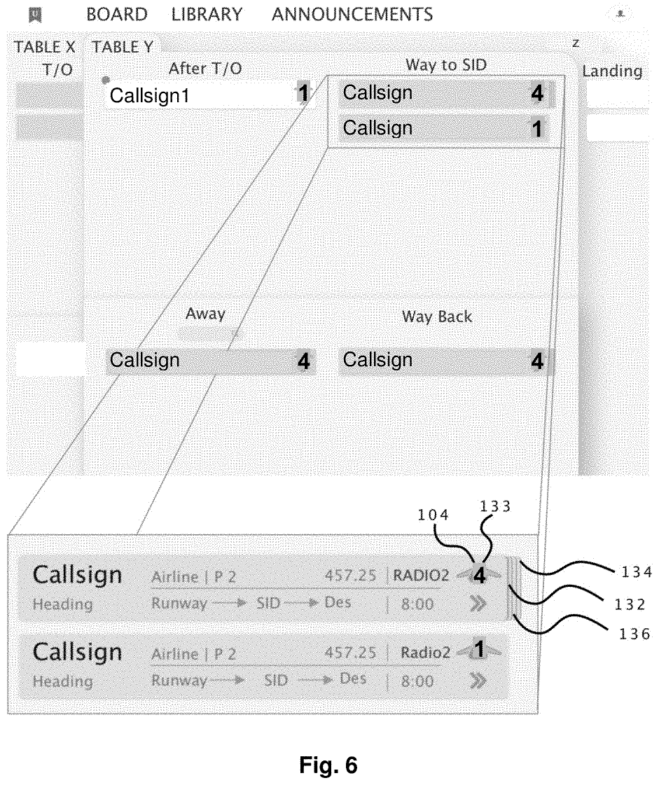

In the arrangement shown, as one example, as shown in the graphical user interface 12 (see FIG. 5) (which is further discussed herein) strips may be modified and grouped. This additional functional display that isn't available in the art didn't allow for grouping and the like. So a single strip 100, and as shown as one example in FIG. 6, may also comprise a group strip 132 or plurality of strips 100 that are displayed as a single strip 100 so that a user can quickly and efficiently manage a plurality of aircraft 22. Additionally, and in this way, a group strip 132 can be expanded to see the plurality of strips grouped therein. A plurality of aircraft grouped into a single strip will show a group stripped indicator, which indicates to a controller and others that the single strip 100 represents more than one aircraft 22. This is also known as a formation display 132.

In the arrangement shown, as one example, as shown in the graphical user interface 12 (which is further discussed herein) strips 100 may be shown in a formation display 134. Formation display 134 may be formed of any suitable size, shape, and design and is configured to provide indications and controls for formations 28. This formation display 134 occurs when a grouped strip 132 is expanded to show all of the strips which were grouped into a single strip 100. In this expanded formation, or formation open display 134, the strip also includes a more information feature 136. More information feature allows a user to access more information, information which is not displayed.

Additionally, and in the arrangement shown, as one example, a strip 100 may include a sort feature 138. Sort feature 138 may be formed of any suitable, size, shape and design. In the arrangement shown, as one example, the sort feature 138 is formed of three horizontal lines on the right side of the strip 100 when a group of strips is shown in the formation open display 134. In this way, a user can click on the three lines and drag the strip 100 vertically, horizontally, or otherwise in order to provide sorting within the group. In this way, a user can organize a group of aircraft 22 within a grouped strip 100 as a user may desire. For example, a user may desire to sort the aircraft by altitude, fuel level, arrival time, or rank of pilot, or any other parameter 23.

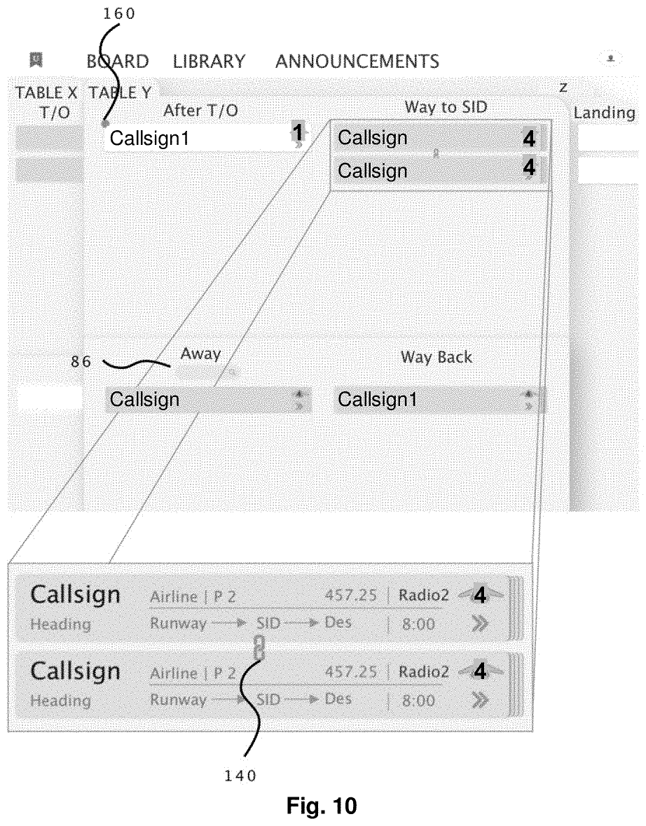

Additionally, and in the arrangement shown, as one example, strips 100 may be linked. In this way graphical user interface 12, as is further discussed herein includes a link feature 140 (see FIG. 10). Link feature 140 may be formed of any suitable size, shape, and design and is configured to combine groups in an effective utilitarian and visual way. In the arrangement shown, as one example, link 140 appears visually as a small chain link which is connected to two strips 100. In this way, a link 140 visually indicates to a user that any commands sent to one strip 100 will also be sent to the linked strip. In this way, a user can send one group of aircraft to join another group and then link the two groups in a way that doesn't combine all of the aircraft of one group to another. For example, a user may desire that group B join group A for a limited duration of time. Linking 140 is an effective means to accomplish this task in system 10.

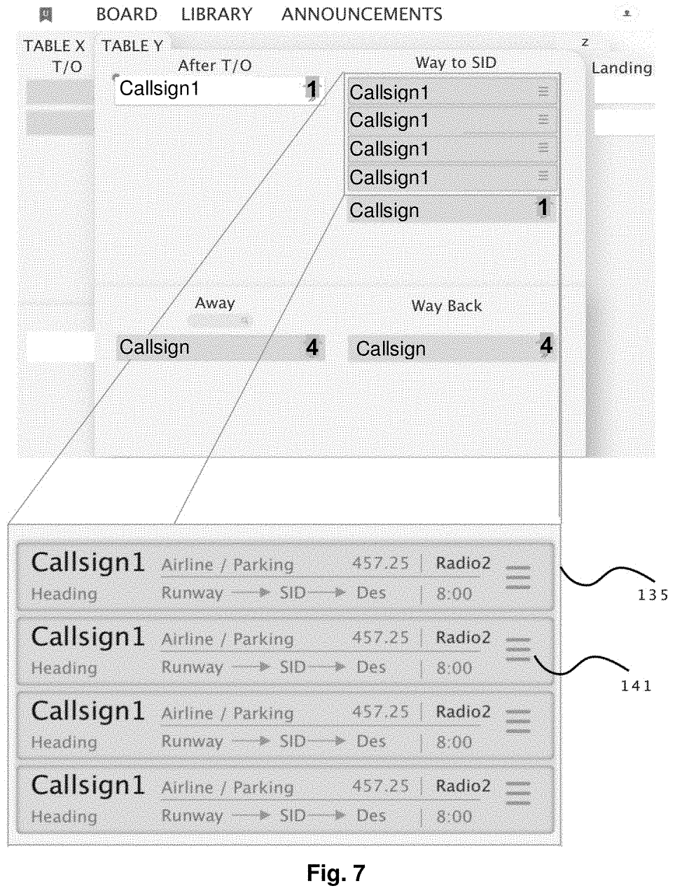

In the arrangement shown, as one example, system 10 also includes a drag feature 141 (see FIG. 7). Drag feature 141 as alluded to herein allows a user the capability to quickly drag a strip from one section to another section of the graphical user interface. Additionally, and in the arrangement as shown, drag feature 141 allows a user to quickly combine two or more aircrafts into a group by dragging a first strip over a second strip 100.

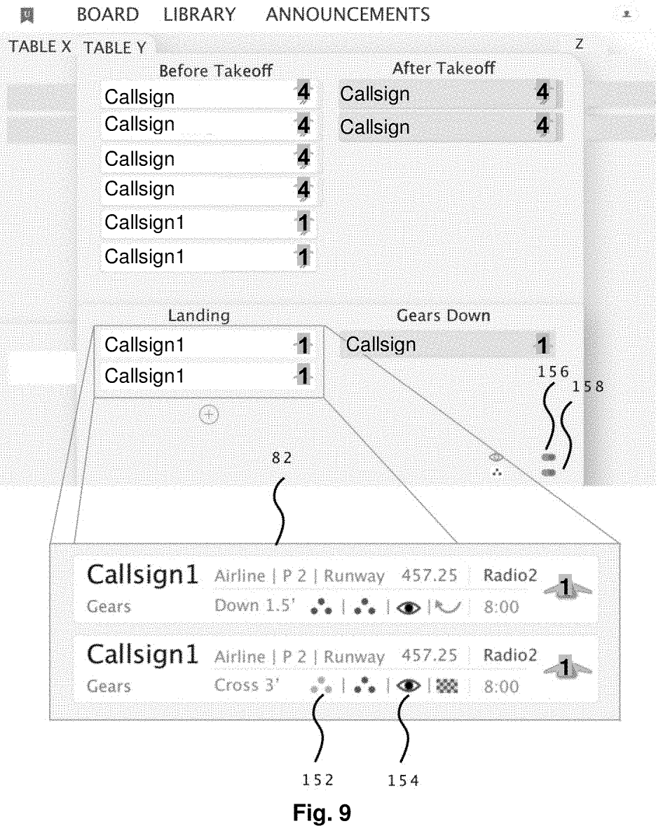

In the arrangement shown, strips 100 can be customized to the convenience of a particular application and/or user. In addition to the various bits of information discussed herein, a strip 100, as shown in the examples herein, may also contain a squad number, a parking location (or “parking”), a runway, an SID, an Area, a UHF, a takeoff time, and the like. Additionally, strip 100 may include a delete function which quickly allows a user to delete a strip 100. Other additional functions or features, as shown in the example herein, include, but are not limited to, a strip feature selector, a feature search, a landing gear indicator 152, a visual indicator 154, a gears down viewer 156, a visual indicator viewer 158, and a notes feature 160, and other components, features and functions. See FIGS. 9 and 10 that show the functional display with some these features, some of which are designated with the reference number above.

Graphical User Interface:

In the arrangement shown, as one example, system 10 includes a graphical user interface 12. Graphical user interface 12 is formed of any suitable size shape and design and is configured to provide a platform that can safely, easily, and effectively manage aircraft formations, squadrons, groups and/or other numbers of air platforms flying or operating together in airspace. Additionally, graphical user interface 12 is configured to provide a system, being interactive in most cases, and method of use that provides familiarity of the current art in a way that the new system can be incorporated safely and used by those with familiarity of existing systems. Additionally, graphical user interface 12 provides a long-felt need in the art for a system and method which improves upon the state of the art while providing a new system that can manage a plurality of aircraft with simplicity, familiarity, efficiency, and effectiveness.

Graphical user interface 12 includes an interactive display for controlling and managing various components and features of system 10. Additionally, graphical user interface 12 provides a means for displaying information of the system and information of real-time data, instructions, and more to a user even if the user isn't interacting with the graphical user interface 12. In this way, the graphical user interface 12 is acting as a display to communicate with pilots and others instructions and the like.

In the arrangement shown, as one example, graphical user interface 12 includes a home page, a board page, a library page, an announcements page, and an admin page, among other pages, features, functions, and components. In this arrangement, as one example, a home or home page, is generally the main page a user utilizes to navigate the graphical user interface 12. In addition, and in the arrangement shown, the home page may also serve as a landing page, often times being the first page or a page by which a user “lands” after opening and/or logging into an account 14 of the graphical user interface 12.

Home Page: In the arrangement shown, as one example, graphical user interface includes a home page. Home page may be formed of any size, shape, and design and may include various features and/or be customized in various ways so as to display information and/or provide a user and/or controller with functions and interactions with the graphical user interface 12 and thus system 10. In the arrangement shown, as one example, home page includes a navigation panel, a plurality of page links, a display, and an account feature, among other options, controls, and components.

In the arrangement shown, as one example, home page includes a navigation panel. Navigation panel is formed of any suitable size, shape, and design and is configured to provide a user with the main means of general navigation across the various functions of the graphical user interface 12. In the arrangement shown, as one example, navigation panel is a generally flat, rectangular bar located horizontally across the upper portion of the graphical user interface 12. In this way, as the eyes move downward from the top of a screen and/or display a user generally starts with the navigation panel.

In the arrangement shown, as one example navigation panel includes a logo and/or indicator that serves as indicating to the user what system 10 they are currently using. Additionally, this logo and/or indicator also can serve as a page link to bring the user back to the home page. In the arrangement shown, logo and/or indicator is in the upper left portion of the display.

Additionally, and in the arrangement shown, as one example, navigation panel includes a plurality of page links. A plurality of page links is formed of any suitable size, shape, and design and configured to display a different page to the user. In this way, each plurality of page links will bring different functionalities and provide different uses of system 10 to a user when that particular page link is selected. In the arrangement shown, as one example, some of the plurality of page links include, but are not limited to, a “Board” page, a “Library” page, an “Announcements” page, and an “Admin” page. These pages can be altered, added to, subtracted from. In this way, the plurality of page links can be customized.

In the arrangement shown, as one example, home page includes a display. Display is formed of any suitable size, shape, and design and is configured to provide the main page of displaying information and/or accessing features of system 10. In this way, and as is shown in one example, display is generally square in shape and exists below the navigation panel. In this way, when a plurality of page links are selected from the navigation panel, the display will change in accordance with the various functionalities of the system 10.

In the arrangement shown, as one example, home page includes an account feature 38. Account feature is formed of any suitable, size, shape, and design and may require various information for a user such as name, login username, password, picture, identification number, security clearances, address, phone number, callsign and the like. In the arrangement shown, as one example, account feature is located at the upper right of the graphical user interface 12, located on the right side of the navigation panel. Additionally, account feature may appear as a start page when a user is logging into the system 10. In this way, a user will be required to enter credentials before accessing graphical user interface 12.

In addition to the above identified features, options, controls, and components, home page may also include other features, options, controls, and components. Additionally, system 10 provides a means for changing the home page and other pages so that the graphical user interface 12 can be customized to better suit the needs of a user.

Board Page: In the arrangement shown, as one example, graphical user interface 12 includes a board page. Board page is formed of any suitable, size, shape, and design and is configured to provide the main functionality of the system 10. Said another way, board page provides the main controls, features, functionality of system 10 and is configured to be the main page that a controller, pilot and the like will interact with.

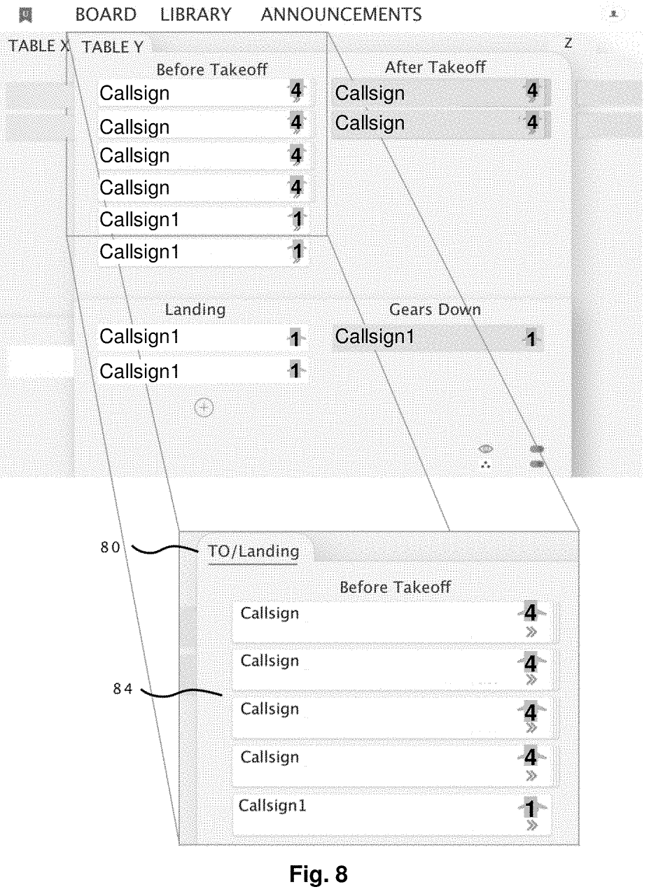

In the arrangement shown, as one example, board page includes a plurality of tabs 42 (or simply “tabs”), see FIG. 5. Tabs 42 can be customized and may vary depending on the setup of each jurisdiction, personal preferences of a user, etc. In the arrangement shown, as one example, tabs 42 are small selector tabs that appear as various individual tabs arranged to easily help a user navigate through various stages of air travel. For example, in the arrangement shown, tabs 42 include a takeoff tab, an approach tab 60, a landing tab 80, and a taxiing tab 90. See FIGS. 8 and 10 that show these tabs in the functional display for particular aircrafts to which callsings are open.

In the arrangement shown, as one example, tabs 42 include a takeoff tab. Takeoff tab is formed of any suitable size, shape, and design, and is configured to provide the sections which serve as both indicators of where a current aircraft or group of aircraft is as well as provide movement of the aircraft or group of aircraft into another section. In other words, the takeoff tab provides a plurality of sections with status dedications. In this way, a controller can move a plurality of strips (strips 100 located within the takeoff tab), by dragging the strip, from one status dedication (or “section”) to another section. As an example, a controller may drag an aircraft strip from a “before takeoff” section to a “takeoff” section to indicate that the aircraft is now about to takeoff. Additionally, as another example, a controller may drag an aircraft and/or group of aircraft from a landing section to gears down section to indicate that this particular aircraft and/or group of aircraft have engaged their landing gear.

The various sections of the takeoff tab may be customized to taste and function, as well as language. Additionally, the takeoff tab is often that starting point, where a strip may be added to and/or created. In this way, the strip may be appearing in the system 10 for the first time or may be retrieved from a database and “brought to life” for the first time. If this particular aircraft has been parked then it may not be active in the graphical user interface 12 but for in a database. In this way, a search feature may be used to retrieve aircraft strips 100 from a database so that a controller can start indicating that the associated aircraft with a particular strip 100 is becoming active.

Additionally, the strips 100, sections, and tabs 42 have a variety of functionality in addition to the add or search features. Some of these other features include, but are not limited to, strip selector feature, a feature search, a landing gear indicator 152, a visual indicator 154, a gears down viewer 156, a visual indicator viewer 158 (for activating or deactivating the visual indicator 154 (see FIG. 9), and a notes feature 160 (see FIG. 10), among other features, components, and functionality.

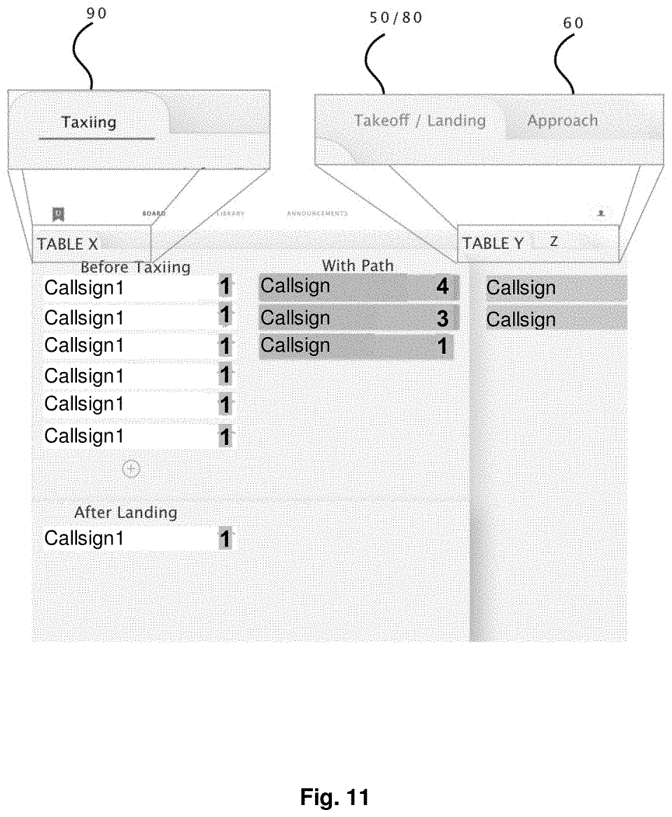

In the arrangement shown, as one example, tab 42 includes an approach tab 60 as shown in FIG. 11. Approach tab 60 is formed of any suitable size, shape, and design, and is configured to provide the sections which serve as both indicators of where a current aircraft or group of aircraft is as well as provide movement of the aircraft or group of aircraft into another section. In other words, the approach tab 60 provides a plurality of sections with status dedications. In this way, a controller can move a plurality of strips (strips 100 located within the approach tab 60), by dragging the strip, from one status dedication (or “section”) to another section. As an example, a controller may drag an aircraft strip from a “after takeoff” section to a “Way to SID” section to indicate that the aircraft has taken off. Additionally, as another example, a controller may drag an aircraft and/or group of aircraft from an “away” section to a “Way Back” section to indicate that this particular aircraft and/or group of aircraft are outbound or inbound.

The various sections of the approach tab 60 may be customized to taste and function, as well as language. Additionally, the approach tab 60 may serve as a starting point, where a strip may be added to and/or created. In this way, the strip may be appearing in the system 10 for the first time or may be retrieved from a database and “brought to life” for the first time. If this particular aircraft has been parked then it may not be active in the graphical user interface 12 but for in a database. In this way, a search feature may be used to retrieve aircraft strips 100 from a database so that a controller can start indicating that the associated aircraft with a particular strip 100 is becoming active.

Additionally, the strips 100, sections, and tabs 42 have a variety of functionality in addition to the add or search features. Some of these other features include, but are not limited to, post takeoff section, a Way to SID section, an away section, a return section (or “way back” section), an add feature 72, strip selector feature, a feature search, a landing gear indicator 152, a visual indicator 154, a gears down viewer 156, a visual indicator viewer 158 (for activating or deactivating the visual indicator 154, and a notes feature 160, among other features, components, and functionality.

In the arrangement shown, as one example, tab 42 includes a landing tab 80 as shown in FIG. 8. Landing tab 80 is formed of any suitable size, shape, and design, and is configured to provide the sections which serve as both indicators of where a current aircraft or group of aircraft is as well as provide movement of the aircraft or group of aircraft into another section. In other words, the landing tab 80 provides a plurality of sections with status dedications. In this way, a controller can move a plurality of strips 84 in FIG. 8 (strips 100 located within the landing tab 80), by dragging the strip, from one status dedication (or “section”) to another section. As an example, a controller may drag an aircraft strip from a “Landing” section to a “Landed” section to indicate that the aircraft has landed. Additionally, a controller may subsequently move this strip to a Taxiing tab as movement from tab to tab is also a possible function.

The various sections of the landing tab 80 may be customized to taste and function, as well as language. Additionally, the landing tab 80 may serve as a starting point, where a strip may be added to and/or created. In this way, the strip may be appearing in the system 10 for the first time or may be retrieved from a database and “brought to life” for the first time. If this particular aircraft has been parked then it may not be active in the graphical user interface 12 but for in a database. In this way, a search feature 86 may be used to retrieve aircraft strips 100 from a database so that a controller can start indicating that the associated aircraft with a particular strip 100 is becoming active.

Additionally, the strips 100, sections, and tabs 42 have a variety of functionality in addition to the add or search features. Some of these other features include, but are not limited to a landing section 82, an add feature 88, strip selector feature, a feature search, a landing gear indicator 152, a visual indicator 154, a gears down viewer 156, a visual indicator viewer 158 (for activating or deactivating the visual indicator 154, and a notes feature 160, among other features, components, and functionality.

In the arrangement shown, as one example, tabs 42 includes a taxiing tab 90, which is shown in the functional display in FIG. 11. Taxiing tab 90 is formed of any suitable size, shape, and design, and is configured to provide the sections which serve as both indicators of where a current aircraft or group of aircraft is as well as provide movement of the aircraft or group of aircraft into another section. In other words, the taxiing tab 90 provides a plurality of sections with status dedications. In this way, a controller can move a plurality of strips (strips 100 located within the taxiing tab 90), by dragging the strip, from one status dedication (or “section”) to another section. As an example, a controller may drag an aircraft strip from a “Before Taxiing” section to a “With Path” section to indicate that the aircraft has landed. Additionally, a controller may subsequently move this strip to a Taxiing tab 90 as movement from tab to tab is also a possible function.

The various sections of the taxiing tab 90 may be customized to taste and function, as well as language. Additionally, the taxiing tab 90 may serve as a starting point, where a strip may be added to and/or created. In this way, the strip may be appearing in the system 10 for the first time or may be retrieved from a database and “brought to life” for the first time. If this particular aircraft has been parked then it may not be active in the graphical user interface 12 but for in a database. In this way, a search feature may be used to retrieve aircraft strips 100 from a database so that a controller can start indicating that the associated aircraft with a particular strip 100 is becoming active.

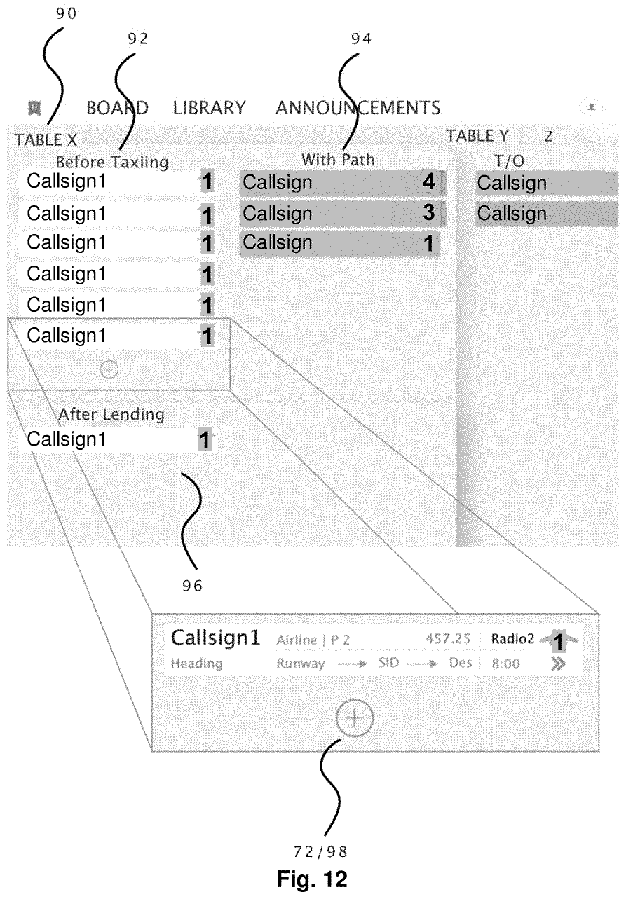

Additionally, the strips 100, sections, and tabs 42 have a variety of functionality in addition to the add or search features. Some of these other features include, but are not limited to a before taxiing section 92, a With Path section 94, an after landing section 96, an add feature 98, strip selector feature, a feature search, a landing gear indicator 152, a visual indicator 154, a gears down viewer 156, a visual indicator viewer 158 (for activating or deactivating the visual indicator 154, and a notes feature 160, among other features, components, and functionality. These functionalities are shown in the functional display in FIG. 12, but see also FIG. 10 for the notes functionality.

Admin Page: In the arrangement shown, as one example, graphical user interface 12 includes an Admin page (or “administration page”). Admin page is formed of any suitable size, shape, and design and is configured to provide settings and customization features for all of the graphical user interface 12. This includes, but is not limited to providing features that allow for account changes, page changes, tab changes, strip customization, section changes and customization, flow customizations, rule creation, and more.

In the arrangement shown, as one example, admin page includes a plurality of admin options, among other options, controls, and components. Admin options, in the arrangement shown as one example, are configured as a list of options arranged vertically along the left side of the display such that a user can easily navigate through the various options and customization features. In the arrangement shown, as one example, these features include users, boards, board order feature, board settings, and rules that all correspond to a set of data and organization of that data.

In the arrangement shown, as one example, admin page includes board tabs. Board tabs as previously discussed as plurality of tabs 42 in association with the board page are the main interaction displays and serve as the main controls of system 10. Board Tabs, are the setup of these tabs. In this way, board tabs can be customized, added to via a board tab add feature. Additionally, sections and parts can be added via a parts feature which can activate and customize a plurality of parts or sections of a board 42.

Additionally, and in the arrangement shown, other customization features of boards include, but are not limited to, a group formation feature, a sort by feature, a next to feature, which can control where a strip is moved to in a subsequent pattern, such as movement of a strip from a “landing” section to a “landed” section; an add new aircraft feature, which allows for the activation and creation of aircraft in some sections but not others; a strip type feature, and more, as can be associated with various sections. In this way, the boards can be customized to a user or particular jurisdiction or desired functionality.

In the arrangement shown, as one example, the board page also includes a Data Feature. Data feature is formed of any suitable, size, shape and design and is configured to provide customization of data types. The data feature allows for activation and deactivation of various types of data associated with a strip 100. In this way, the appearance of strips can be customized as needed. Strips 100 display a plurality of information, some of which may be required by local flight agencies and government restrictions. This section allows strips to be customized to satisfy any applicable laws and regulations. Additionally, this part allows strips to be customized to the likings of a user or crew that is completing an operation or controlling an aircraft and/or group of aircraft.

In the data types part, a user can activate or deactivate parts of a strip 100 from appearing on the strips 100. For example, a user may not wish to have the callsign displayed on all of the strips. A user can deactivate callsign. In another example, perhaps a user doesn't wish to have landing gear status appear on the strips when the aircraft are taxiing, as taxiing aircraft likely always have landing gear engaged and the status will not change. The user can customize what data appear and when that data of a strip 100 appears.

In the arrangement shown, as one example, admin page includes a rules feature (or “rules generator feature”). Rules feature is formed of any suitable size, shape, and design and is configured to create automatic functionality of system 10. In other words, the rule feature allows a user to create custom rules at which system 10 must operate.

Furthermore, in certain conditions, certain laws, regulations, or custom, must require certain operations to follow certain rules. These rules can be pre-programmed. Other rules can be created down to the customizations of a particular user. For example, if a particular flight controller desires that all aircraft strips 100 appear on the “Inbound” section the moment they enter a 100 mile radius, then the system can be customized with this set of rules which populates the strip associated with the aircraft entering a 100 mile radius of the aircraft controller. Likewise, perhaps a controller prefers all aircraft strips in the “Outbound” section automatically be removed from the section once they exit mile radius, or exit a 10,000 feet altitude from the controller. In this way many rules and customizations can be created. Various if, then functions can work, and various rules that also continue to learn preferences can be used. In this way, system 10 is capable of machine learning and can adjust to the desires and general customs of a controller or jurisdiction. Additionally, new rules can be added, deleted, and machine learning can be turned off. These rules and other algorithms can be pre-programmed and/or programmed into system 10 to operate through the graphical user interface 12 or behind the scenes in a predetermined manner of operation.

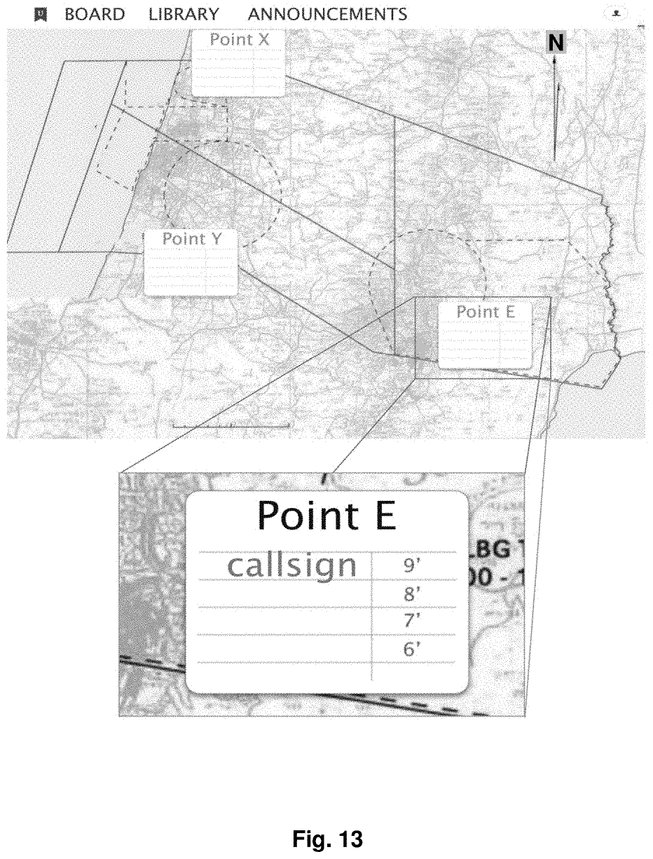

This is exemplified in FIG. 14, illustrating display of aircraft formations in a defined, controlled airspace, where every aircraft symbol is assigned a formation number and identified with a different callsign assigned to them These callssigns are assigned to them at lift off/departure or when grouped to formations. For the purpose of monitoring the aircrafts in this airspace, the ground control/control tower in charge can group their callsigns in the functional display and monitor and coordinate their flight routes as a single flight strip until leaving the airspace bounds. FIG. 13 illustrates dedicated flight data, routes and altitudes of different aircrafts and aircraft formations in an airspace. The control system of the present invention identifies formations and aircrafts according to their flight data, particularly altitude and destination, and prevents conflicts between them by allowing dedicated, different altitudes to different formations At the same time, the control system does not allow assigning the same altitude and route to different aircrafts and formation in its controlled airspace. The routes of identified aircrafts are monitored within a defined and controlled airspace by monitoring their callsigns as they travel between different points in the airspace. The tables for every point may be continuously populated and unpopulated with identifying callsigns as aircrafts enter and travel through the airspace. This improves the supervision of and control over aircraft traffic within the borders of the airspace.

In Operation/Method of Use:

An aircraft management system and method of use for verifying the authenticity of products for a grouping aircraft and providing a more efficient and safe system of aircraft management is presented herein. This method of use of the system 10 through a graphical user interface 12 is inherently disclosed. This method of use and others are hereby disclosed. The system is inherently disclosed with a variety of methods of use and functionality as rules can change and be customized.

It will be appreciated by those skilled in the art that other various modifications could be made to the system without parting from the spirit and scope of this disclosure. All such modifications and changes fall within the scope of the claims and are intended to be covered thereby.

### REFERENCE NUMERALS

10—System
12—Graphical User Interface
14—Account
16—Controller
20—Viewer
22—Aircraft
23—Aircraft Parameter
24—Plurality of Access Points
25—GUI
26—Map/Board
27—Mobile GUI
28—Formation
282—Airspace
284—Direction
286—Altitude
288—Distance X
290—Distance Y
100—Strip (“flight strip”)
104—Number of Aircraft (of 100)
132—Group Strip
133—Group Strip Indicator
134—Formation Display
135—Formation Open Display
136—More Information Feature
140—Link
141—Drag Feature
152—Landing Gear Indicator
154—Visual Indicator
156—Gears Down Viewer
158—Visual Indicator Viewer
160—Notes Feature
42—Plurality of Tabs
60—Approach Tab (of 42)
72—Add Feature
80—Landing Tab (of 42)
82—Landing Section
84—Plurality of strips
86—Search Feature
88—Add Feature
90—Taxiing Tab (of 42)
92—Before Taxiing Section
94—With Path Section
96—After Landing Section
98—Add Feature
170—Control System (FIGS. 5&6)
300—Application Server
302—Database
306—Processor
308—Memory
312—Computer
314—Data Analysis
316—Data Analysis Grouping Output

1. An aircraft management system, comprising:
an application server;
an application programming interface;
a database;
a graphical user interface;
the graphical user interface comprising a dashboard;
the graphical user interface comprising a plurality of stages;
a plurality of flight strips;
the plurality of flight strips each representing an aircraft;
wherein the system combines a plurality of flight strips into a group;
wherein the group can be represented by a single flight strip.

2. The system of claim 1, further comprising the graphical user interface comprising a dashboard.

3. The system of claim 1, further comprising the graphical user interface comprising a dashboard;
the dashboard comprising a plurality of sections;
wherein the plurality of flight strips can be moved throughout the plurality of sections according to a flight stage.

4. The system of claim 1, further comprising the graphical user interface comprising a dashboard;
the dashboard comprising a plurality of sections;
wherein the group can be moved throughout the plurality of sections according to a flight stage.

5. The system of claim 1, further comprising the graphical user interface comprising a dashboard;
the dashboard comprising a plurality of sections;
wherein the aircraft management system moves the plurality of flight strips from a first section to a second section by a set of predetermined rules.

6. The system of claim 1, further comprising the graphical user interface comprising a dashboard;
the dashboard comprising a plurality of sections;
wherein the aircraft management system moves the plurality of flight strips from a first section to a second section by a set of learned rules.

7. The system of claim 1, further comprising:
the plurality of flight strips comprising a plurality of parameters.

8. The system of claim 1, further comprising:
the graphical user interface comprising a home page, a board page, and an admin page.

9. The system of claim 1, further comprising:
wherein the system autonomously groups the plurality of flight strips based on a predefined set of parameters.

10. The system of claim 1, further comprising:
wherein the system autonomously groups the plurality of flight strips based on a predefined set of parameters;
wherein the predefined set of parameters are modified through machine learning.

11. An aircraft management system, comprising:
an application server;
an application programming interface;
a database;
a graphical user interface;
the graphical user interface comprising a home page, a board page, and an admin page;
the graphical user interface comprising a dashboard;
the graphical user interface comprising a plurality of stages;
a plurality of flight strips;
the plurality of flight strips each representing an aircraft.

12. The system of claim 11, further comprising:
a status;
a control system;
data;
wherein the status of a plurality of aircraft is updated in real-time according to data sent from the control system to the plurality of flight strips.

13. The system of claim 11, wherein the group of aircrafts is displayed on a single strip;
the single strip comprising an expansion feature;
wherein the expansion feature can be used to view additional information corresponding to each aircraft associated with the group.

14. The system of claim 11, further comprising:
a set of flight instructions;
an electronic transmission;
a flight strip;
the flight strip comprising at least one parameter;
wherein when the at least one parameter of the flight strip is changed, the change is updated by electronic transmission and viewable in real time to anyone viewing the flight strip.

15. An aircraft management system, comprising:
an application server;
an application programming interface;
a database;
a graphical user interface;
the graphical user interface comprising a dashboard;
the graphical user interface comprising a plurality of stages;
a plurality of flight strips;
the plurality of flight strips each representing an aircraft;
wherein the system combines a plurality of flight strips into a first group;
wherein the system combines a plurality of flight strips into a second group;
wherein the first group can be represented by a single flight strip;
wherein the second group can be represented by a single flight strip;
a link;
wherein the first group and the second group can be linked by the link;
wherein control of the first group affects control of the second group.

16. The system of claim 15, further comprising the graphical user interface comprising a dashboard;
the dashboard comprising a plurality of sections;
wherein the aircraft management system moves the plurality of flight strips from a first section to a second section by a set of learned rules.

17. The system of claim 15, further comprising:
the plurality of flight strips comprising a plurality of parameters.

18. The system of claim 15, further comprising:
the graphical user interface comprising a home page, a board page, and an admin page.

19. A method of managing aircraft, the steps comprising:
providing an aircraft management system;
providing an application server;
providing an application programming interface;
providing a database wherein the database comprises datasets;
providing a graphical user interface;
providing at least one flight strip;
wherein each of the at least one flight strips represent an aircraft.

20. The method of claim 19, further comprising:
combining the at least one flight strips into a single group wherein the single group is represented by a single flight strip;
delivering instructions to the group simultaneously by changing a parameter of the single flight strip.

21. The method of claim 19, further comprising:
wherein the graphical user interface includes a dashboard comprising a plurality of sections.

22. The method of claim 19, further comprising:
delivering a set of instructions to the at least one flight strip autonomously, by the aircraft management system, by a set of learned rules.
